(19) United States
(12) Patent Application Publication
(10) Pub. No.: US 2010/0010853 A1
(43) Pub. Date: Jan. 14, 2010

(54) METHOD AND APPARATUS FOR ANALYZING BUSINESS PROCESS FLOW

(75) Inventor: Keisuke YANO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/500,422

(22) Filed: Jul. 9, 2009

(30) Foreign Application Priority Data
Jul. 11, 2008 (JP) 2008-180976

(51) Int. Cl. G06Q 10/00; G06T 11/20

(52) U.S. Cl. 705/7; 345/440

(57) ABSTRACT

An apparatus includes: an extracting unit to extract, from a data storage section, a process instance having a business event associated with a specific attribute having a range of attribute values, there being stored in the data storage section a plurality of process instances for which a series of business events are arranged in time series, and attribute values of one or a plurality of attributes associated with each business event; a specifying unit to specify transitions between the business events included in the extracted process instance in each given range, and to specify one amongst the given ranges in which the extracted process instance is relatively most changed based on transition between specified business events; and an output unit to produce a flowchart including a flow in which the process instances extracted in the specified process are superimposed on each other, and to output the flowchart.

### CROSS-REFERENCE TO RELATED APPLICATIONS

This application is based upon and claims the benefit of priority of the prior Japanese Patent Application No. 2008-180976, filed on Jul. 11, 2008, the entire contents of which are incorporated herein by reference.

### FIELD

This technique relates to the field of a technique for analyzing a business process flow.

### BACKGROUND

For example, for the purpose of BPR (business process re-engineering), there has been already known a technique by which data produced in a business system employed in enterprises, etc. is collected and analyzed to automatically produce a business process flow. In the technique, since the business process flow is extracted from business data produced by actually conducting business, a frequency at which each business process flow is produced is analyzed to facilitate recognizing a business process flow in frequency, specifying the same as an exceptional flow and alerting a user accordingly. As a related document, there is Japanese Laid-open Patent Publication No. 2005-115494.

### SUMMARY

According to an embodiment of the invention, a business process flow analyzing apparatus can includes: an extracting unit to extract, from a data storage section, a process instance having a business event associated with a specific attribute, the specific attribute having a range of attribute values, there being stored in the data storage section a plurality of process instances for which a series of business events are arranged in time series, and attribute values of one or a plurality of attributes associated with each business event; a specifying unit to specify transitions between the business events included in the extracted process instance in each given range, and to specify one amongst the given ranges in which the extracted process instance is relatively most changed based on transition between specified business events; and an output unit to produce a flowchart including a flow in which the process instances extracted in the specified process are superimposed on each other, and to output the flowchart to a user interface device.

Advantages, etc., of the invention may be realized and attained by elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a business process flow analyzing apparatus according to an example of an embodiment of the invention.

FIG. 2 is a diagram illustrating an example of data stored in a flow table of a process instance data storage section according to an example of an embodiment of the invention.

FIG. 3 is a diagram illustrating an example of data stored in an attribute table of the process instance data storage section according to an example of an embodiment of the invention.

FIG. 4 is a diagram illustrating an example of data stored in an event table of the process instance data storage section according to an example of an embodiment of the invention.

FIG. 5 is a diagram illustrating a main process flow according to an example of an embodiment of the invention.

FIG. 6 is a diagram illustrating a first screen example according to an example of an embodiment of the invention.

FIG. 7 is a diagram illustrating a process flow of a process instance extracting process according to an example of an embodiment of the invention.

FIG. 8 is a diagram illustrating a first example of the superimposing result of process instances according to an example of an embodiment of the invention.

FIG. 9 is a diagram illustrating a second screen example according to an example of an embodiment of the invention.

FIG. 10 is a diagram illustrating a second example of the superimposing result of process instances according to an example of an embodiment of the invention.

FIG. 11 is a diagram illustrating a third example of the superimposing result of process instances according to an example of an embodiment of the invention.

FIG. 12 is a diagram illustrating a fourth example of the superimposing result of process instances according to an example of an embodiment of the invention.

FIG. 13A is a diagram showing a process flow of a change-point extracting and displaying process according to an example of an embodiment of the invention.

FIG. 13B is a diagram illustrating a process flow of the change-point extracting and display process according to an example of an embodiment of the invention.

FIG. 14 is a diagram illustrating the processing result of a change-point extracting section according to an example of an embodiment of the invention.

FIG. 15 is a diagram illustrating the processing result of the change-point extracting section according to an example of an embodiment of the invention.

FIG. 16 is a diagram illustrating the processing result of the change-point extracting section according to an example of an embodiment of the invention.

FIG. 17 is a diagram illustrating a third screen example according to an example of an embodiment of the invention.

FIG. 18 is a functional block diagram of a computer which represents an example of how to implement of an embodiment of the invention.

### DESCRIPTION OF EMBODIMENTS

Initially, a brief discussion of terminology is presented. A business flow has one or more attributes. Each attribute of the business flow can take on one of a plurality of values, i.e., the attribute can exhibit an attribute value. For the purposes of simplifying the discussion, when discussing the attribute but not a particular value which the attribute may exhibit at a given time, the present discussion will refer to the specific attribute. By contrast, when discussing particular values which a specific attribute may manifest, the present discussion will refer to a value of the specific attribute and/or to an attribute value.

The above-mentioned Background Art technique adopts an idea that a business process flow is classified into a main flow and an exceptional flow based on a frequency at which the business process flow is produced. However, the Background Art technique has focused no attention on an attribute value of an attribute such as “amount” or “numerical quantity” which is associated with the business process flow. For example, the attribute value may be significantly different between a business process flow higher in sales and a business process flow lower in sales. Because the Background Art technique has focused no attention on the value of the attribute, then it is difficult to adaptively change the business process flow according to the attribute value. Also, because the Background Art technique focused no attention on the value of the attribute, it is frequently difficult to manually specify a characteristic point according to a relationship between the attribute value of the specific attribute associated with the business process flow and the business process flow.

A business process flow analyzing method according to this embodiment includes: extracting a process instance having a business event associated with the specific attribute whose attribute value belongs to a given range in each given range of the attribute value of the specific attribute, from a data storage section that stores a plurality of process instances in which a series of business events implemented are arranged in time, and the attribute values of one or a plurality of attributes associated with each business event; specifying transition between the business events included in the extracted process instance in each given range, and specifying the given range in which the extracted process instance is most changed based on transition between the specified business events; and producing a flowchart including a flow in which the process instances extracted in the specified process are superimposed on each other, and outputting the flowchart to an output section.

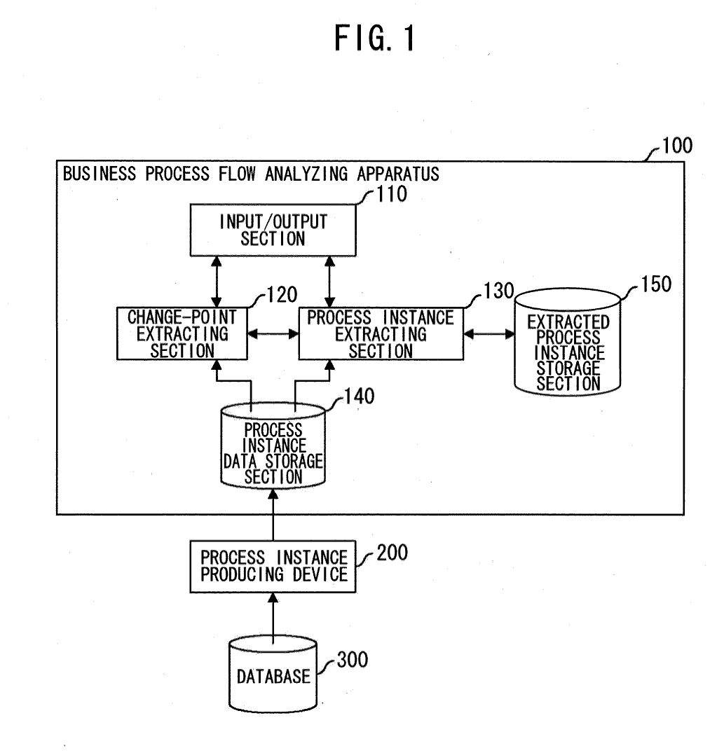

FIG. 1 shows a functional block diagram showing a business process flow analyzing apparatus 100 according to an embodiment of this technique. The business process flow analyzing apparatus 100 according to this embodiment includes: an input/output section 110 that is an interface with a user or a user terminal and produces data to be presented to the user; a process instance data storage section 140 that stores various data related to process instances therein; a process instance extracting section 130 that implements a process of extracting a specific process instance by the aid of data stored in the process instance data storage section 140; an extracted process instance storage section 150 that stores data of the process instance extracted by the process instance extracting section 130, etc., therein; and a change-point extracting section 120 that extracts a characteristic point in a relationship between the business process flow and the specific attribute by the aid of data cooperated with the process instance extracting section 130 and stored in the process instance data storage section 140. The input/output section 110 executes processing in cooperation with the change-point extracting section 120 and the process instance extracting section 130. Also, the input/output section 110 is connected to an output device such as a display device or a printing device when the business process flow analyzing apparatus 100 is a device of the stand-alone type. Also, the input/output section 110 transmits display data to a user terminal and allows the user terminal to conduct display, etc. when the business process flow analyzing apparatus 100 is connected to the user terminal over a network.

Also, a process instance producing device 200 is provided in which business data is put together in time series from a database 300 that stores business data produced by the business system (for example, record produced in each business event) therein to produce a large number of process instances. However, the process instance producing device 200 can be realized by the conventional device described in the above background section, and is not a main part in this embodiment. Therefore, further description thereof will be omitted.

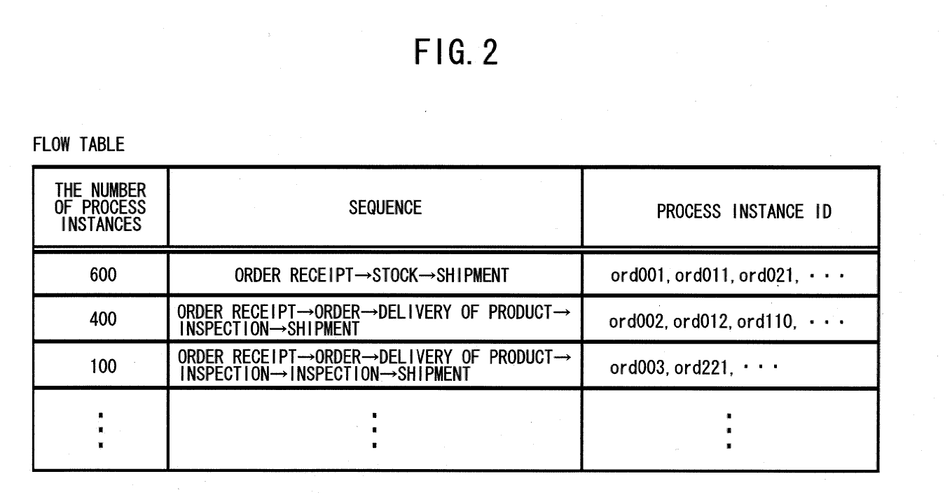

An example of data stored in the process instance data storage section 140 will be described with reference to FIGS. 2 to 4. The data does not have to be managed by tables described below, and any management form that makes the above data available may be applied.

FIG. 2 shows an example of a flow table. In the flow table of FIG. 2, the number of process instances, a sequence representative of the appearance order of the business events in each type of the process instances, and IDs of the process instance belonging to each type of the process instances are registered in each type of process instances.

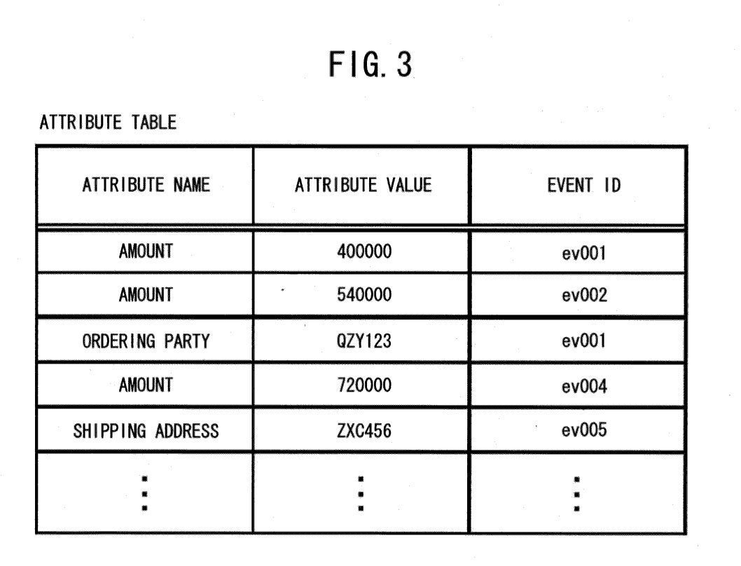

FIG. 3 shows an example of an attribute table. In the attribute table of FIG. 3 are registered attribute names, attribute values, and ID of the event associated with the attribute. Even identical events may be associated with a plurality of attributes.

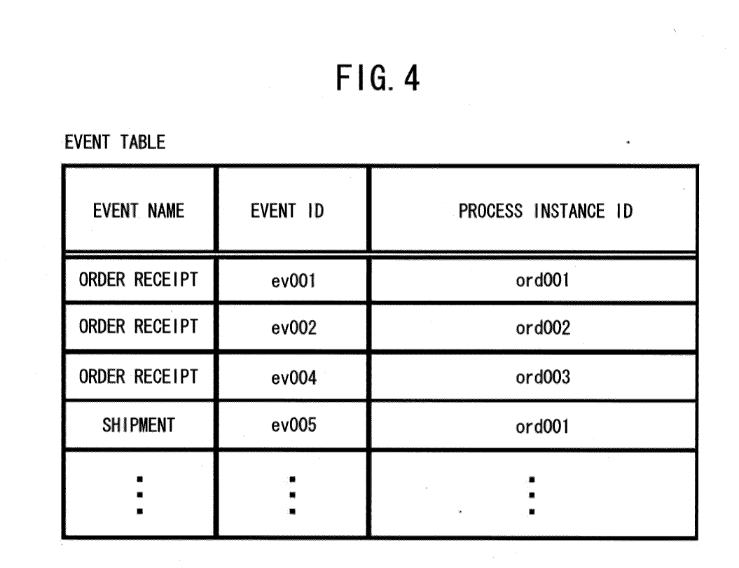

FIG. 4 shows an example of an event table. In the event table of FIG. 4 are registered event names, event IDs, and IDs of the process instances of the events.

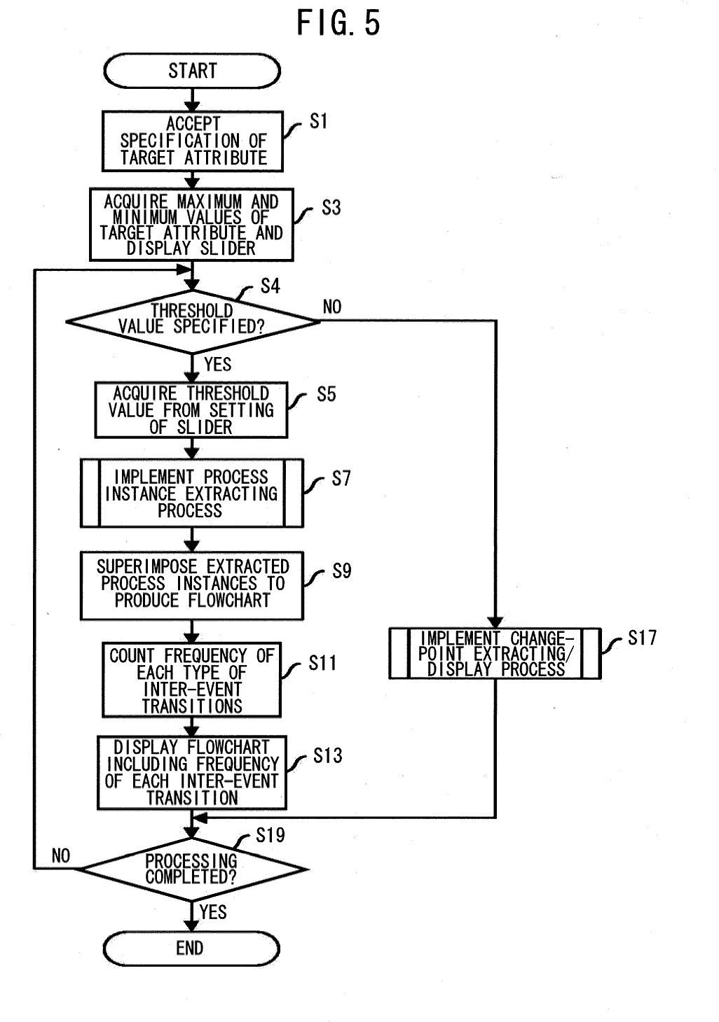

Subsequently, the processing contents of the business process flow analyzing apparatus 100 will be described with reference to FIGS. 5 to 17. First, the input/output section 110 encourages the user to specify a target attribute, and accepts the specification of the target attribute from the user (Step S1). For example, the input/output section 110 accepts an input of the attribute name. When ID is allocated to the attribute, the attribute name may be replaced with ID of the attribute.

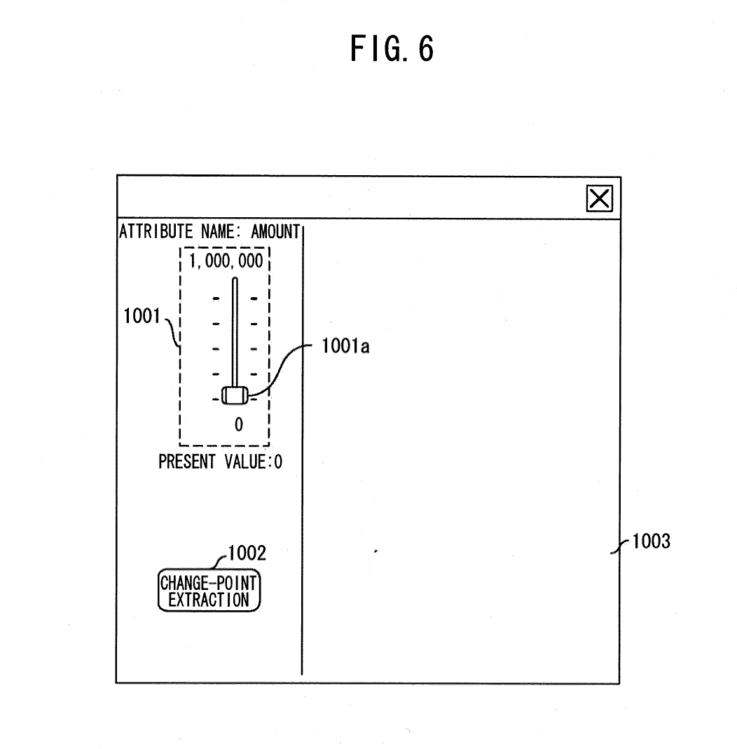

Subsequently, the input/output section 110 outputs the target attribute to, for example, the process instance extracting section 130, and requests the process instance extracting section 130 to acquire the maximum and minimum values of the target attribute. On the contrary, the process instance extracting section 130 retrieves, for example, the attribute table in the process instance data storage section 140 by the target attribute to acquire the appropriate attribute value, specifies the maximum and minimum values, and outputs the attribute values to the input/output section 110. Upon receiving the maximum and minimum values of the target attribute from the process instance extracting section 130, the input/output section 110 executes display, for example, with a slider shown in FIG. 6 (Step S3). An example of a screen displayed in Step S3 is shown in FIG. 6. The screen example of FIG. 6, e.g., as might be generated by a graphical user interface (“GUI”) device, is a screen example when “amount” is selected as the target attribute, which includes, at the left side of the screen, a slider 1001 with a lug 1001a, indication of a present value (“0” in this example), and a change-point extraction button 1002. A scale on the slider 1001 ranges from the minimum value “0” to the maximum value “1000000” of the target attribute extracted from the process instance data storage section 140. The present value is displayed by a value indicated by the lug 1001a of the slider 1001. A right column 1003 of the screen is a blank space in FIG. 6, but displays a business process flow in which the appropriate process instances are superimposed on each other as will be described below. From this display, the user moves the lug 1001a of the process slider 1001 so as to set the target value in the target attribute “amount”.

Alternatively, processing in Step S3 is not executed, but a scale being in a range set in correspondence with the attribute in advance may be displayed on the slider 1001.

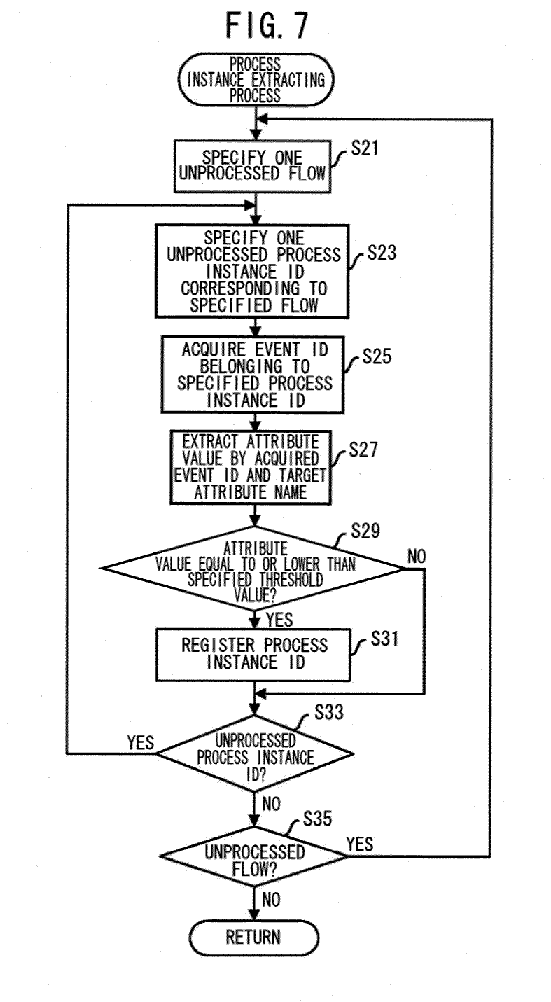

Subsequently, the input/output section 110 determines whether the user adjusts the lug 1001a of the slider 1001 to set the attribute value of the target attribute, that is, a threshold value of the attribute value, or not (Step S4). When the threshold value has been set, the input/output section 110 acquires a threshold value used in the following processing from setting of the slider 1001, and outputs a process instance extraction request with the target attribute and the threshold value to the process instance extracting section 130 (Step S5). Upon receiving the process instance extraction request with the target attribute and the threshold value from the input/output section 110, the process instance extracting section 130 implements a process instance extracting process (Step S7). The process instance extracting process will be described with reference to FIGS. 7 to 12.

The process instance extracting section 130 specifies one of unprocessed flows (that is, the process instance type) from the flow table of the process instance data storage section 140 (Step S21). Then, the process instance extracting section 130 specifies one of unprocessed process instance IDs corresponding to the specified flow (process instance type) (Step S23). In this situation, the process instance extracting section 130 acquires an event ID belonging to the specified process instance ID from the event table of the process instance data storage section 140 (Step S25). In the example of FIG. 4, in the case of ord001, ev001 (order receipt) and ev005 (shipment) are extracted.

Then, the process instance extracting section 130 retrieves an attribute table of the process instance data storage section 140 by the acquired event ID and the target attribute name, and extracts the appropriate attribute value (Step S27). For example, when the process instance extracting section 130 retrieves the attribute table shown in FIG. 3 by “amount” of the target attribute and ev001, “400000” is extracted.

Further, the process instance extracting section 130 compares the extracted attribute value with the specified threshold value to determine whether the extracted attribute value is equal to or lower than the specified threshold value, or not (Step S29). When the specified threshold value is “600000”, and the extracted attribute value is “400000”, determination is made that the extracted attribute value is equal to or lower than the specified threshold value.

Accordingly, when the extracted attribute value is equal to or lower than the specified threshold value, the process instance extracting section 130 registers the process instance ID specified in Step S23 in the extraction process instance storage section 150 in correspondence with data specifying the flow (process instance type) specified in Step S21 (Step S31). For example, in the same data structure as that of the flow table shown in FIG. 2, only the process instance ID whose extracted attribute value is equal to or lower than the specified threshold value is registered. Thereafter, processing is shifted to Step S33. On the other hand, when the extracted attribute value is larger than the specified threshold value, processing is shifted to Step S33.

Then, the process instance extracting section 130 determines whether the unprocessed process instance ID exists or not (Step S33). When the unprocessed process instance ID exists, processing is returned to Step S23. On the other hand, when no unprocessed process instance ID exists, the process instance extracting section 130 determines whether the unprocessed flow (process instance type) exists, or not (Step S35). When the unprocessed flow (process instance type) exists, processing is returned to Step S21. On the other hand, when no unprocessed flow (process instance type) exists, processing is returned to original processing.

With the above processing, data of the process instance having the target attribute whose attribute value is equal to or lower than the specified threshold value is registered in the extraction process instance storage section 150.

The process instance extracting section 130 outputs data registered in the extraction process instance storage section 150 to the input/output section 110. The input/output section 110 stores data received from the process instance extracting section 130 in a storage device such as a main memory.

Returning to description of the processing of FIG. 5, the input/output section 110 superimposes the process instances received from the process instance extracting section 130 on each other to produce a flowchart (Step S9). The superimposing process of the process instances is in the conventional art, but when a brief description is made, parts in which transition occurs between the identical events in the plurality of process instances are coordinated, and transition between different kinds of events is added to the coordinated business process flow to produce one business process flow in which patterns of all process instances appear. For example, the produced flowchart is stored in the storage device such as the main memory.

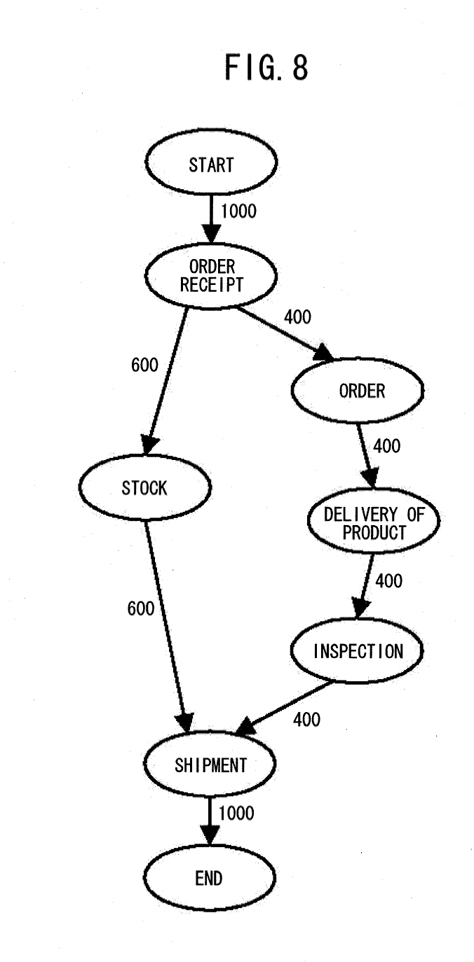

For example, a flowchart produced when the above-described target attribute is “amount”, and the attribute value being a threshold value is “600000” is shown in, for example, FIG. 8. For the purposes of facilitating discussion, it is noted that FIG. 8 (and for that matter most of the other FIGS. in the present disclosure) recites hypothetical values, i.e., non-limiting values. In an example of FIG. 8, it is found that a process instance in which transitions occur between events in the stated order of “order receipt”, “stock”, and “shipment”, and a process instance in which transitions occur between events in the stated order of “order receipt”, “order”, “delivery of a product”, “inspection”, and “shipment” are superimposed on each other between “start” and “end”.

Then, the input/output section 110 counts the occurrence frequency of each type of the inter-event transitions in all the process instances received from the process instance extracting section 130, and stores the count value in the storage device such as a main memory (Step S11). As shown also in FIG. 8, the number of inter-event transitions occurring from “start” to “order receipt” is 1000 and is as large as the total number of extracted process instances. The number of inter-event transitions occurring from “order receipt” to “stock” is 600 and represents one part of the number of extracted process instances. The number of inter-event transitions occurring from “order receipt” to “order” is 400 and represents another part of the number of extracted process instances. Thus, the process instance extracting section 130 counts the occurrence frequency with respect to each type of the inter-event transitions.

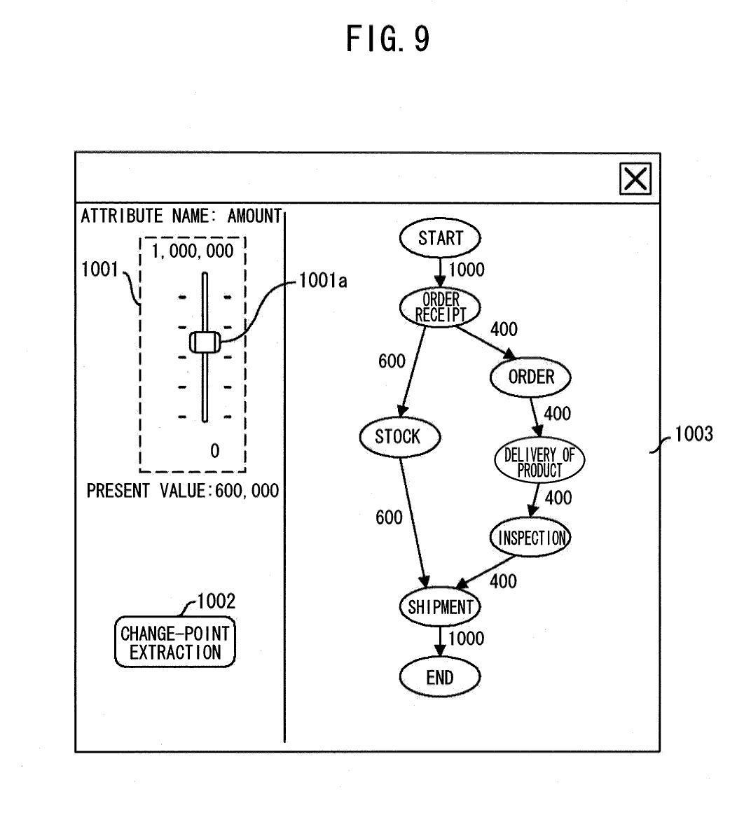

Thereafter, the input/output section 110 produces a flowchart including the occurrence frequency of each type of the inter-event transitions, which is counted in Step S1, and outputs the flowchart to the user terminal or the user (Step S13). For example, a screen shown in FIG. 9 is displayed. The lug 1001a of the slider 1001 indicates “600000” according to a user's instruction, and a flowchart produced from the process instance whose target attribute “amount” is “600000” with the above value as a threshold value is included in the right display column 1003.

With execution of the above display, the user can grasp the condition of the process instance associated with the attribute value of the target attribute being equal to or lower than a specific attribute value.

The user can freely specify the threshold value by moving the lug 1001a of the slider 1001, and can find out the attribute value of the target attribute which becomes a change point in a relationship between the attribute value of the target attribute and the configuration of the process instance by adjusting the threshold by the operator.

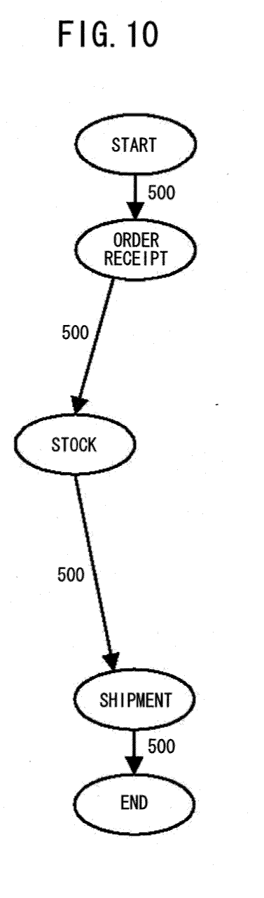

For example, an example of a flowchart when the threshold value of the target attribute “amount” is set to “500000” in the above-described example is shown in FIG. 10. In the example of FIG. 10, it is understood that events of “order receipt”, “stock”, and “shipment” occur from “start” to “end”, only one route exists, and all of process instances equal to or lower than the threshold value pass through that route.

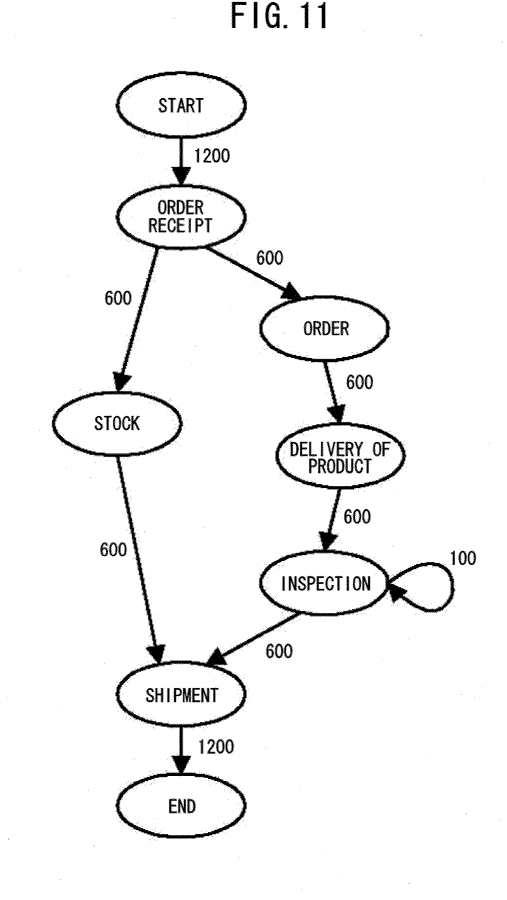

A flowchart when the threshold value of the target attribute “amount” is set to “800000” in the above-described example is shown in FIG. 11. It is understood that an example of FIG. 11 is similar to the flowchart of FIG. 8 when the threshold value is “600000”, but self-transition to “inspection” occurs.

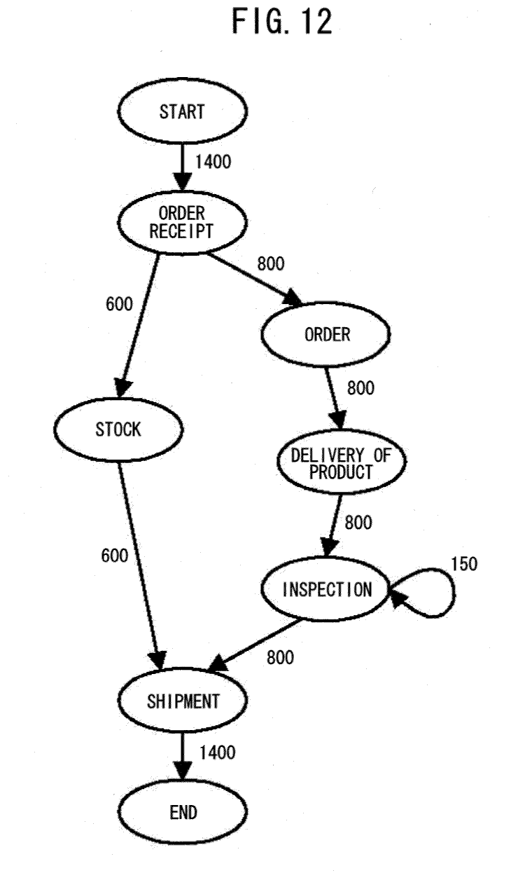

A flowchart when the threshold value of the target attribute “amount” is set to “1000000” in the above-described example is shown in FIG. 12. It is understood that an example of FIG. 12 is identical with the flowchart when the threshold value is “800000” without any change. Although the occurrence frequency of the inter-event transitions naturally changes, the occurrence frequency of the inter-event transitions increases only on a route of “order receipt”, “order”, “delivery of a product”, “inspection”, and “shipment”.

Processing is shifted from Step S13 to Step S19, and the input/output section 110 determines whether the completion of processing is instructed by the user, or not (Step S19). When the completion of processing is not instructed by the user, processing is returned to Step S4. Alternatively, processing may be returned to Step S1. On the other hand, when the completion of processing is instructed, processing is completed according to the instruction.

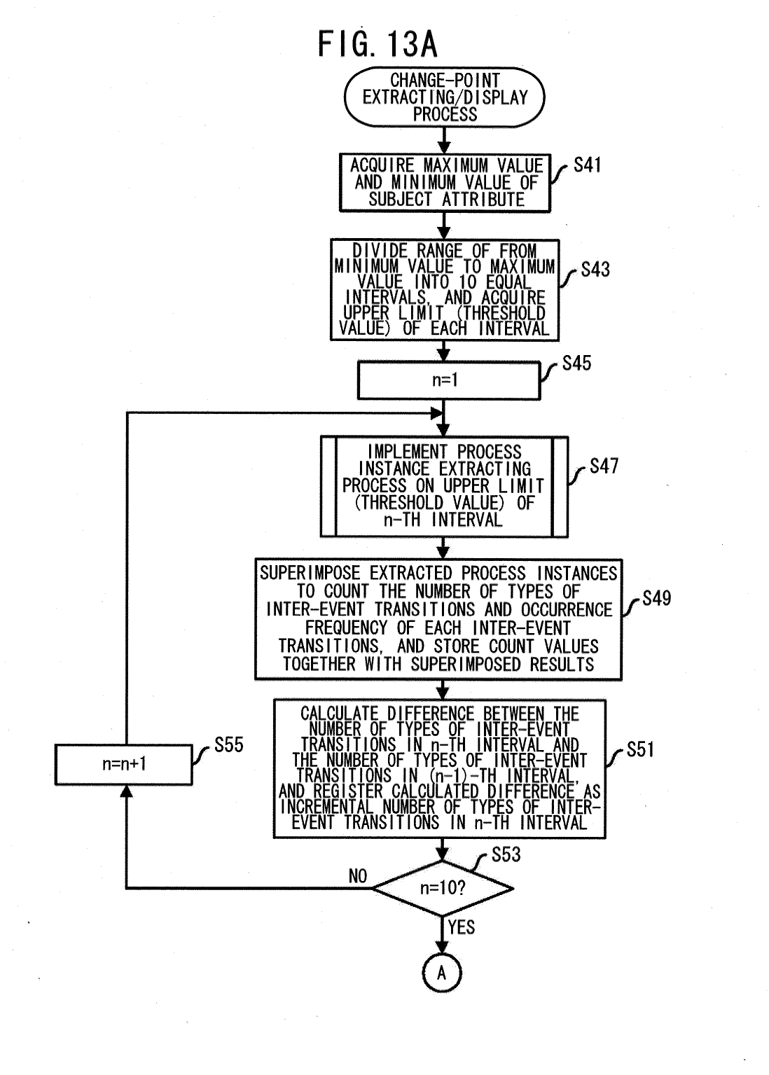

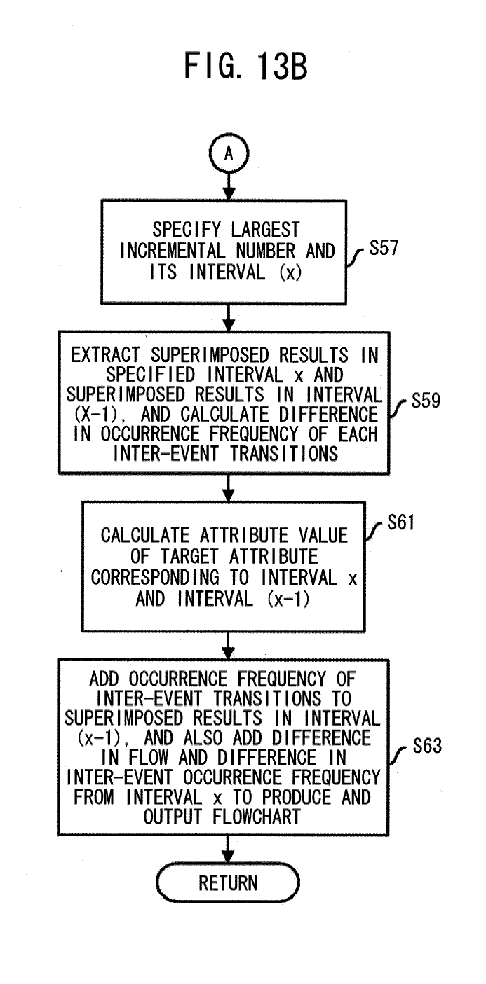

On the other hand, for example, when the change-point extraction button 1002 in the screen example of FIG. 9 is clicked, it is determined that the threshold value is not specified in Step S4, and the input/output section 110 implements a change-point extracting/display process in cooperation with the change-point extracting section 120 (Step S17). The change-point extracting/display process will be described with reference to FIGS. 13A to 17. Processing is shifted from Step S17 to Step S19.

Subsequently, the contents of the change-point extracting/display process will be described. First, the change-point extracting section 120 acquires the maximum and minimum values of the target attribute from the attribute table of the process instance data storage section 140 according to data of the target attribute received from the input/output section 110 (Step S41). Then, the change-point extracting section 120 divides a range of from the minimum value to the maximum value into 10 equal intervals (10 equal intervals for example, and other division numbers may be applied), and calculates the upper limit (threshold value) of each interval (Step S43). When the range is from the minimum value “0” to the maximum value “1000000”, a threshold value of a first interval is “100000”, a threshold value of a second interval is “200000”, a threshold value of a third interval is “300000”, a threshold value of a fourth interval is “400000”, a threshold value of a fifth interval is “500000”, a threshold value of a sixth interval is “600000”, a threshold value of a seventh interval is “700000”, a threshold value of an eighth interval is “800000”, a threshold value of a ninth interval is “900000”, and a threshold value of a tenth interval is “1000000”.

Then, the change-point extracting section 120 initializes a counter n to 1 (Step S45), outputs an upper limit (threshold value) of an n-th interval to the process instance extracting section 130, and implements the process instance extracting process for the above threshold value (Step S47). The processing contents are described with reference to FIG. 7, and therefore their details will be omitted. In the above description, the processing results are output to the input/output section 110, but the present processing request is made by the change-point extracting section 120, and therefore the processing results are output to the change-point extracting section 120. The change-point extracting section 120 stores data of the received process instance in the storage device such as a main memory.

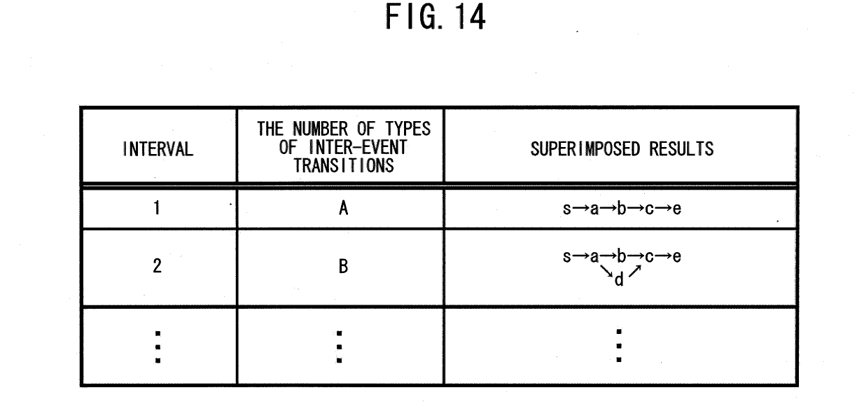

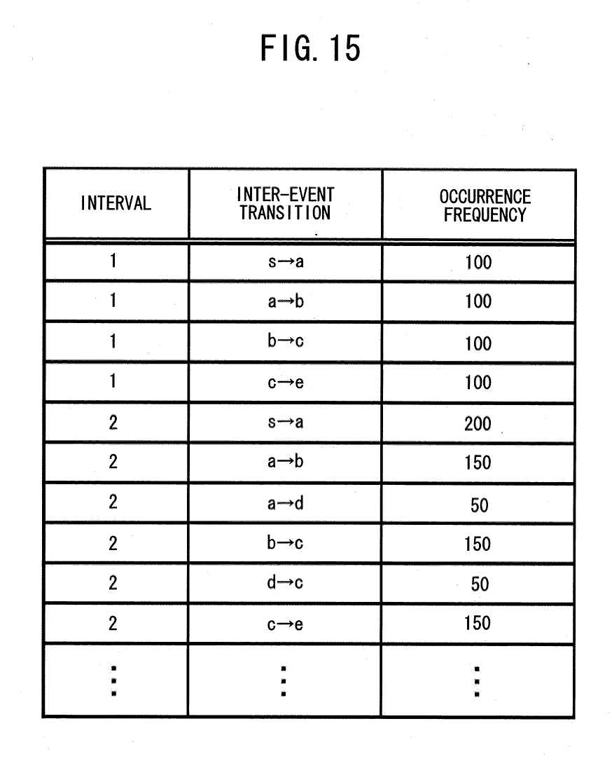

The change-point extracting section 120 superimposes the extracted process instances on each other, counts the number of types of inter-event transitions and the occurrence frequency of each inter-event transition in the extracted process instance, and stores the counted values together with data of a flowchart showing the superimposed results in the storage device such as a main memory (Step S49). The change-point extracting section 120 stores, for example, data shown in FIGS. 14 and 15. In an example of FIG. 14, in each interval, the number of types of inter-event transitions and the superimposed results (may be representative of a sequence of events, data of the flowchart, or a pointer to a file) are registered. Also, in an example of FIG. 15, in each type of inter-event transitions which appear in each interval, the count value of occurrence frequency is registered.

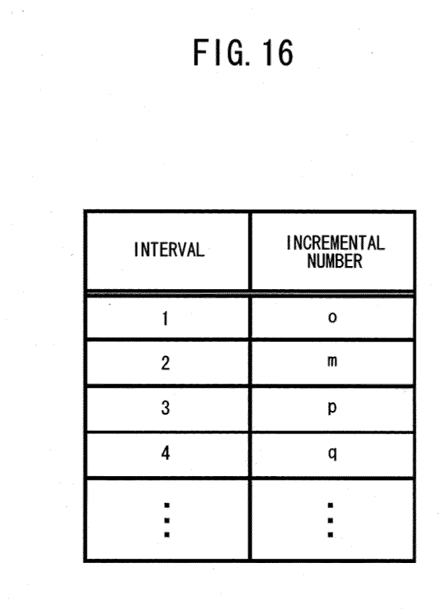

Further, the change-point extracting section 120 calculates a difference between the number of types of inter-event transitions in the n-th interval and the number of types of inter-event transitions in an (n−1)-th interval. Then, the change-point extracting section 120 stores the calculated difference as an incremental number of types of inter-event transitions in the n-th interval in the storage device such as a main memory (Step S51). In the first interval, the increment is set to “0”. As shown in FIG. 16, the incremental number thus calculated is registered in each interval. In this embodiment, since the process instances are extracted in a range of from the lower limit of the entire range to the upper limit of each interval, the types of inter-event transitions are not decreased in number.

Then, the change-point extracting section 120 determines whether n reaches 10 (number of intervals), or not (Step S53). When n has not yet reached 10, n is incremented by 1 (Step S55), and processing is shifted to Step S47. On the other hand, when n has reached 10, processing is shifted to the processing of FIG. 13B through a terminal A.

Shifting description to the processing of FIG. 13B, the change-point extracting section 120 specifies the largest incremental number in the processing results of Step S51, and its interval (Step S57). For example, it is assumed that the sixth interval (the interval of “600000” in the upper limit) is specified in the above example. In the following description, it is assumed that the specified interval is an x-th interval which is represented as an interval x.

With the above processing, the change-point extracting section 120 extracts a difference between the superimposing result in the specified interval x and the superimposing result in the interval (x−1) from the processing results of Step S49, calculates a difference in the occurrence frequency of each inter-event transition in the interval x and the interval (x−1), and stores the calculated difference in the storage device such as a main memory (Step S59). For example, when it is assumed that the sixth interval is specified, an interval to be compared is the fifth interval. That is, the flowchart shown in FIG. 8 and the flowchart shown in FIG. 10 are to be compared with each other. Accordingly, in this example, in Step S59, a route of order receipt, order, delivery of a product, inspection, and shipment in the stated order is extracted as the difference. Also, the difference in the occurrence frequency in each inter-event transition is “500” between start and order receipt, “100” between order receipt and stock, “100” between stock and shipment, “400” between order receipt and order, between order and delivery of a product, between delivery of a product and inspection, and between inspection and shipment, and “500” between shipment and end.

Further, the change-point extracting section 120 calculates the attribute values (that is, the threshold values (upper limits)) of the target attributes corresponding to the interval x and the interval (x−1), and stores the calculated attribute values in the storage device such as a memory (Step S61). When the results of Step S43 can be used, it is only necessary to read the attribute values from the calculation results, particularly, in this step.

Then, the change-point extracting section 120 outputs the attribute values (upper limits) and internal Nos. of the interval x and the interval (x−1), the results of superimposing the process instances in the interval (x−1), the difference in the flow between the interval x and the interval (x−1), the occurrence frequency of each inter-event transitions in the interval (x−1), and the difference in the occurrence frequency of inter-event transitions between the interval x and the interval (x−1) to the input/output section 110.

The input/output section 110 adds the inter-event transition occurrence frequency in the interval (x−1) to the results of superimposing the process instances in the interval (x−1), also adds the difference in the flow from the interval x and the difference in the inter-event transition occurrence frequency from the interval x thereto to produce a flowchart, and outputs the flowchart to an output device such as a display device or a printing device, etc. (Step S63).

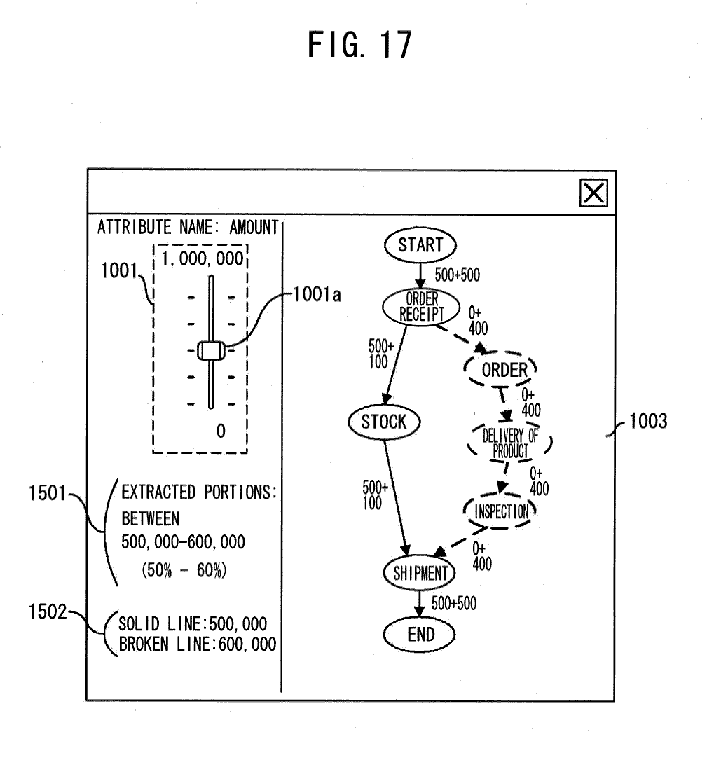

For example, in an example of FIG. 17, the lug 1001a of the slider 1001 is indicative of, for example, “500000” being the attribute value of the interval (x−1). Also, data 1501 and 1502 on a left column are representative of a rate (50%) specified by the attribute value (“500000”) and interval No. of the interval (x−1), and a rate (60%) specified by the attribute value (“600000”) and interval No. of the interval x by numeric values, respectively. On the right display column 1003, the flowchart being the superimposing results in the interval (x−1) is represented by a solid line, and the difference in the flow from the interval x is represented by a dotted line. The dotted line is merely one display form, and can be replaced with a bold line, blinking representation, color change representation if the difference can be emphasized. Although the display is based on the interval (x−1), the difference is added to the display with the result that the superimposing results in the interval (x−1) are displayed. Also, in each inter-event transition, the inter-event transition occurrence frequency in the interval (x−1) is indicated in a first item, and the difference in the inter-event transition occurrence frequency from the interval x is indicated in a second item.

With the above display, when attention is paid to a specific attribute, the attribute value at which the business process flow changes significantly, if not maximally, can be automatically extracted, and the contents of the change can be so visualized as to be easily understandable.

Similarly, in the example of FIG. 17, when the amount exceeds “500000”, a sequence of events “order”, “delivery of a product”, and “inspection” occurs, thereby making it possible to also easily grasp an increase in the occurrence frequency of the process instance.

One embodiment of this technique has been described above, but this technique is not limited to this embodiment. For example, the process instances are extracted with the fixed lower limit, but the lower limit can be made variable. Further, although the numeric attribute is assumed for the target attribute in the above description, when the appropriate process instance is merely extracted, the attribute being not the numeric attribute can be selected as the target attribute. In this case, the respective attribute values are enumerated in the slider for allowing selection.

Further, the functional block diagram shown in FIG. 1 shows one example, and may not always coincide with a real program module configuration. The process instance producing device 200 may be included in the business process flow analyzing device 100.

In the processing flow, the processing order may be changed, or the processing may be executed in parallel when the substantially same processing results are obtained.

Further, a configuration can be made in which the business process flow analyzing device 100 is connected to a network, and implements the above-mentioned processing according to a request from a user terminal connected to the network, and returns the processing results to the user terminal.

In FIG. 13A, n is incremented, but may be decremented.

Also, in configuring the screen in FIG. 17, an example in which the screen is configured on the basis of the interval (x−1) is shown. Alternatively, the screen may be configured on the basis of the interval x. The common part may be emphasized. The flow in the interval x and the flow in the interval (x−1) may be displayed side-by-side.

The configurations according to this technique described above are summarized as follows.

This business process flow analyzing method includes: extracting a process instance having a business event associated with a specific attribute whose attribute value belongs to a given range in each the given range of the attribute value of the specific attribute, from a data storage section that stores a plurality of process instances in which a series of business events implemented are arranged in time series, and the attribute values of one or a plurality of attributes associated with each business event; specifying transitions between the business events included in the extracted process instance in each given range, and specifying the given range in which the extracted process instance is most changed based on transitions between the specified business events; and producing a flowchart including a flow in which the process instances extracted in the specified given range are superimposed on each other, and outputting the flowchart to an output section to an output section (for example, a display device, a printing device, a user terminal connected thereto via a network, etc.).

With implementation of the above processing, a characteristic point can be automatically extracted in a relationship between the attribute value of the specific attribute associated with the business process flow and the business process flow.

The above-mentioned specifying may include firstly specifying the transitions between the business events included in the extracted process instance in each given range, and counting the number of types of transitions between the business events; and a secondly specifying the given range in which the extracted process instance is most changed on the basis of the counted number of types of transitions between the business events. When the number of types of transitions between the business events is changed, since the entire business process flow also changes, the change can be used for making a decision.

Further, the above-mentioned given range may include a plurality of ranges in each of which the minimum value of the specific attribute is fixed as the lower limit, and the upper limit is changed. The above-mentioned secondly specifying may include calculating a difference between the number of types of transitions between the business events in a specific range and the number of types of transitions between the business events in a previous range in ascending or descending order of the upper limit, and specifying a range in which the difference is largest as a given range in which the process instance is most changed. Since the number of types of transitions between the business events is on the increase or on the decrease in the above-mentioned given range, it is possible to calculate the difference in the number of types in order, and extract the given range in which the difference most increases or decreases.

Further, the above-mentioned given range may include a plurality of ranges in each of which the minimum value of the specific attribute is fixed as the lower limit, and the upper limit is changed. The above-mentioned specifying may include comparing transitions between the business events in a specific range with transitions between the business events in a previous range in ascending or descending order of the upper limit, and specifying a first range in which the extracted process instance is most changed, and a second range just before the first range. In this case, the outputting includes extracting the difference between the flow in which the extracted process instances are superimposed on each other in the first range and the flow in which the extracted process instances are superimposed on each other in the second range, and producing the flowchart including a flow in which the extracted process instances are superimposed on each other in the first range so as to emphasize the difference, and outputting the flowchart. With the above processing, the user can easily grasp the business process flow.

Also, the above-mentioned flowchart may include a slider having a scale ranging from the minimum value to the maximum value of the specific attribute and a lug indicative of a value corresponding to the given range in the scale. Further, the flowchart may display the attribute value of the specific attribute corresponding to the specified given range.

The method according to this technique can produce a program executable by a computer, and the program is stored in a computer-readable storage medium or storage device such as a flexible disc, a CD-ROM, a magneto-optical disc, a semiconductor memory, or a hard disc. Also, the program may be distributed by digital signals via a network. Data that is being processed is temporarily stored in the storage device such as a memory of the computer.

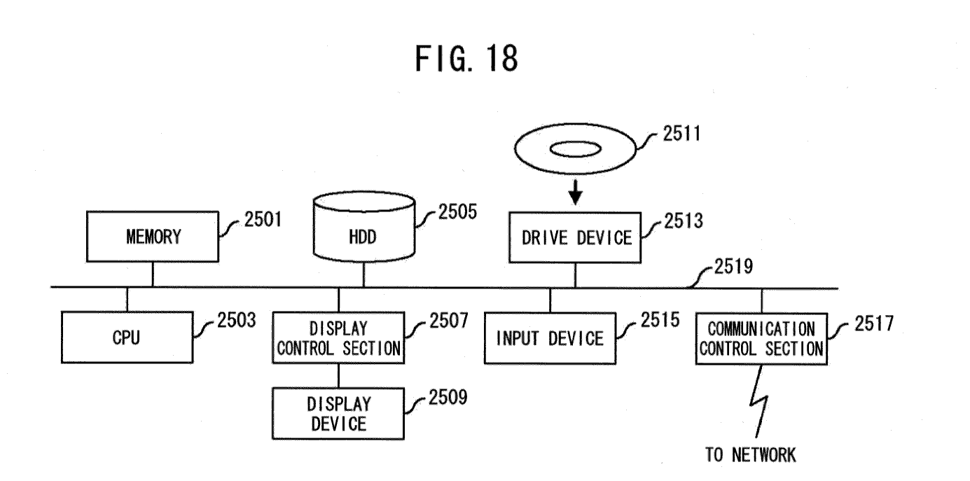

Also, the business process flow analyzing device 100 is a computer device, and as shown in FIG. 18, a memory 2501, a CPU 2503, a hard disc drive (HDD) 2505, a display control section 2507 connected to a display device 2509, a drive device 2513 for a removable disc 2511, an input device 2515, and a communication control section 2517 for connection to a network are connected to each other via a bus 2519. An operating system (OS: Operating System) and an application program for implementing the processing in this embodiment are stored in the HDD 2505. The operating system and the application program are read from the HDD 2505 into the memory 2501 when being executed by the CPU 2503. As occasion demands, the CPU 2503 controls the display control section 2507, the communication control section 2517, and the drive device 2513 for execution of desired operation. Also, data that is being processed is stored in the memory 2501, and stored in the HDD 2505 as occasion demands. In this embodiment of this technique, the application program for implementing the above-mentioned processing is stored in the computer-readable removable disc 2511 and distributed, and installed into the HDD 2505 from the drive device 2513. The application program may be installed in the HDD 2505 via a network such as the Internet and the communication control section 2517. The computer device of this type realizes the above-mentioned various functions by allowing hardware such as the above-mentioned CPU 2503 and memory 2501 organically to cooperate with a corresponding application program(s).

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A medium comprising computer-executable instructions for performing a method, execution of which by a computer facilitates analyzing a business process flow, the method comprising:
extracting, from a data storage section, a process instance having a business event associated with a specific attribute, the specific attribute having a range of attribute values, there being stored in the data storage section a plurality of process instances for which a series of business events are arranged in time series, and attribute values of one or a plurality of attributes associated with each business event;
specifying transitions between the business events included in the extracted process instance in each given range, and specifying one amongst the given ranges in which the extracted process instance is relatively most changed based on transition between specified business events;
producing a flowchart including a flow in which the process instances extracted in the specified process are superimposed on each other; and
outputting the flowchart to a user interface device.

2. The medium according to claim 1, wherein the specifying comprises:
recognizing the transitions between the business events included in the extracted process instance in each given range, and counting the number of types of transitions between the business events; and
identifying the given range in which the extracted process instance is relatively most changed based on the counted number of types of transitions between the business events.

3. The medium according to claim 2,
wherein the given range includes a plurality of ranges in each of which the minimum value of the specific attribute is fixed as the lower limit, and the upper limit is changed, and
wherein the identifying includes,
calculating a difference between the number of types of transitions between the business events in a specific range and the number of types of transitions between the number of types of transitions between the business events in ascending or descending order of the upper limit, and
determining a range in which the difference is largest as a given range in which the process instance is relatively most changed.

4. The medium according to claim 1,
wherein the given range includes a plurality of ranges in each of which the minimum value of the specific attribute is fixed as the lower limit, and the upper limit is changed,
wherein the specifying includes,
comparing transitions between the business events in a specific range with transitions between the business events in a previous range in ascending or descending order of the upper limit, and
setting a first range in which the extracted process instance is relatively most changed, and a second range just before the first range, and
wherein the outputting includes,
extracting a difference between a flow in which the extracted process instances are superimposed on each other in the first range and a flow in which the extracted process instances are superimposed on each other in the second range;
producing a flowchart including a flow in which the extracted process instances are superimposed on each other in the first range so as to emphasize the difference; and
providing the flowchart to the user interface device.

5. The medium according to claim 1,
wherein the producing of a flowchart comprises generating a graphical user interface that represents the flowchart, a slider having a scale ranging from the minimum value to the maximum value of the specific attribute, and a lug indicative of a value corresponding to the given range in the scale.

6. A business process flow analyzing method to be executed by a computer, the method comprising:
extracting, from a data storage section, a process instance having a business event associated with a specific attribute, the specific attribute having a range of values, there being stored in the data storage section a plurality of process instances for which a series of business events are arranged in time series, and the attribute values of one or a plurality of attributes associated with each business event;
specifying transitions between the business events included in the extracted process instance in each given range, and specifying one amongst the given ranges in which the extracted process instance is relatively most changed based on transition between specified business events; and
producing a flowchart including a flow in which the process instances extracted in the specified process are superimposed on each other; and
outputting the flowchart to a user interface device.

7. The method according to claim 6, wherein the specifying comprises:
recognizing the transitions between the business events included in the extracted process instance in each given range, and counting the number of types of transitions between the business events; and
identifying the given range in which the extracted process instance is relatively most changed based on the counted number of types of transitions between the business events.

8. The method according to claim 7,
wherein the given range includes a plurality of ranges in each of which the minimum value of the specific attribute is fixed as the lower limit, and the upper limit is changed, and
wherein the identifying includes,
calculating a difference between the number of types of transitions between the business events in a specific range and the number of types of transitions between the number of types of transitions between the business events in ascending or descending order of the upper limit, and
determining a range in which the difference is largest as a given range in which the process instance is relatively most changed.

9. The method according to claim 6,
wherein the given range includes a plurality of ranges in each of which the minimum value of the specific attribute is fixed as the lower limit, and the upper limit is changed,
wherein the specifying includes,
comparing transitions between the business events in a specific range with transitions between the business events in a previous range in ascending or descending order of the upper limit, and
setting a first range in which the extracted process instance is relatively most changed, and a second range just before the first range, and
wherein the outputting includes,
extracting a difference between a flow in which the extracted process instances are superimposed on each other in the first range and a flow in which the extracted process instances are superimposed on each other in the second range;
producing a flowchart including a flow in which the extracted process instances are superimposed on each other in the first range so as to emphasize the difference; and
providing the flowchart to the user interface device.

10. The method according to claim 6,
wherein the producing of a flowchart comprises generating a graphical user interface that represents the flowchart, a slider having a scale ranging from the minimum value to the maximum value of the specific attribute, and a lug indicative of a value corresponding to the given range in the scale.

11. A business process flow analyzing apparatus comprising:
an extracting unit to extract, from a data storage section, a process instance having a business event associated with a specific attribute, the specific attribute having a range of attribute values, there being stored in the data storage section a plurality of process instances for which a series of business events are arranged in time series, and attribute values of one or a plurality of attributes associated with each business event;
a specifying unit to specify transitions between the business events included in the extracted process instance in each given range, and to specify one amongst the given ranges in which the extracted process instance is relatively most changed based on transition between specified business events; and
an output unit to produce a flowchart including a flow in which the process instances extracted in the specified process are superimposed on each other, and to output the flowchart to a user interface device.

12. The apparatus according to claim 11, wherein the specifying unit comprises:
a recognizing unit to recognize the transitions between the business events included in the extracted process instance in each given range, and to count the number of types of transitions between the business events; and
an identifying unit to identify the given range in which the extracted process instance is relatively most changed based on the counted number of types of transitions between the business events.

13. The apparatus according to claim 12,
wherein the given range includes a plurality of ranges in each of which the minimum value of the specific attribute is fixed as the lower limit, and the upper limit is changed, and
wherein the identifying unit includes,
a calculator to calculate a difference between the number of types of transitions between the business events in a specific range and the number of types of transitions between the number of types of transitions between the business events in ascending or descending order of the upper limit, and
a determination unit to determine a range in which the difference is largest as a given range in which the process instance is relatively most changed.

14. The apparatus according to claim 11,
wherein the given range includes a plurality of ranges in each of which the minimum value of the specific attribute is fixed as the lower limit, and the upper limit is changed,
wherein the specifying unit includes,
a comparing unit to compare transitions between the business events in a specific range with transitions between the business events in a previous range in ascending or descending order of the upper limit, and
a setting unit to set a first range in which the extracted process instance is relatively most changed, and a second range just before the first range, and
wherein the outputting unit includes,
an extraction unit to extract a difference between a flow in which the extracted process instances are superimposed on each other in the first range and a flow in which the extracted process instances are superimposed on each other in the second range;
a generator to generate a flowchart including a flow in which the extracted process instances are superimposed on each other in the first range so as to emphasize the difference, the generator being operable to provide the flowchart to the user interface device.

15. The apparatus according to claim 11,
wherein the generator is further operable to generate a graphical user interface that represents the flowchart, a slider having a scale ranging from the minimum value to the maximum value of the specific attribute, and a lug indicative of a value corresponding to the given range in the scale.
